(19) United States
(12) Patent Application Publication
(10) Pub. No.: US 2025/0014040 A1
(43) Pub. Date: Jan. 9, 2025

(54) MACHINE LEARNING ANALYSIS OF USER INTERACTIONS

(71) Applicant: CITIGROUP TECHNOLOGY, INC., Weehawken, NJ (US)

(72) Inventors: Brandon Smith, Gibsonton, FL (US); Mathew Klotz, Tampa, FL (US); Nicholas Lincoln, Riverview, FL (US); Steve Dayton, Brandon, FL (US); Neeraj Kumar, Brandon, FL (US); Lenny Rodriguez, Apollo Beach, FL (US); Miriam Silver, Tel Aviv (IL)

(21) Appl. No.: 18/240,057

(22) Filed: Aug. 30, 2023

Related U.S. Application Data
(63) Continuation-in-part of application No. 15/497,434, filed on Apr. 26, 2017, now abandoned.

(51) Int. Cl. G06Q 20/40; H04L 67/306; H04L 67/50

(52) U.S. Cl. CPC G06Q 20/4016; H04L 67/306; H04L 67/535

(57) ABSTRACT

Methods and systems for using machine learning systems to create models that define a first tier of initial event case users and user accounts, a second tier of users and user accounts that are interaction counterparties of first tier user accounts, and a third tier of users and user accounts that are interaction counterparties of second tier customer accounts. The processor may then identify first and second tier users and user accounts affiliated with an a fraudulent case history and may classify each first tier user according to risk based on interaction counterparty account links to various second tier users or links to various third tier users via interaction counterparty account links between second and third tier users.

### CROSS REFERENCE TO RELATED APPLICATIONS

This application claims priority to and is a continuation-in-part of co-pending U.S. patent application Ser. No. 15/497,434 filed Apr. 26, 2017, entitled “Methods and Systems for Network Analysis and Modeling of Electronic Data”, the entire contents of which are hereby expressly incorporated herein by this reference including, without limitation, the specification, claims, and abstract, as well as any figures, tables, or drawings thereof.

### FIELD OF THE INVENTION

The present invention relates generally to the field of network analysis and modeling, and more particularly to methods and systems for using machine learning for analyzing and modeling of electronic data related to ascertain or assess risk influence between users of an entity inside the entity's internal network.

### BACKGROUND OF THE INVENTION

Entities that manage user interactions generate many thousands of alerts of suspicious activity. Such current models may typically focus, for example, on direct linkages between users of the entity or users with external entities. The direct linkages are only identified when interactions between the users meet monitoring model criteria. Experience has proven that current models may generate numerous unproductive alerts that indicate suspicious activity is anticipated, but none is found. Significant numbers of unproductive alerts may mean significantly higher compliance costs and such unproductive alerts and subsequent cases partially obscures or shrouds the actual risk within the entity's client population.

It has been theorized and applied in the field of social networks, that individuals who are tied together in a social network may have social influence on one another. One observation of social networks is that the social influence of an individual may dissipate as it propagates through the network until it becomes negligible. The point at which the influence of the individual becomes negligible may typically be three degrees of connection away from such individual, referred to as a “network horizon”. Thus, it is believed that the direct network influence of an individual in a social network may be insignificant at or beyond a social frontier or network horizon that lies at the third step of connection.

This social network horizon effect theory has not been previously investigated for a possible application in modeling risk. There is a need to determine, for example, whether or not a user associated with a risk concern actually has a direct influence on another user or another set of users. For example, it may be possible to determine that risk factors may be significantly isolated from a majority of a user population of an entity, such as an institution, that represents little-to-no risk or threat. Thus, millions of dollars may be saved annually as a result of fraud case volume reduction and wasted time. Further, non-obvious risk associations may be illuminated that are otherwise not generating alerts or cases in the current modeling system.

There is a present need for a solution that resolves all of the foregoing issues and provides, for example, improved methods and systems for analysis and modeling data related to behavior that may be likely to be associated, for example, with fraudulent activities that are not currently available.

### SUMMARY OF THE INVENTION

Embodiments of the invention employ computer hardware and software, including, without limitation, one or more processors coupled to memory and non-transitory computer-readable storage media with one or more executable programs stored thereon which instruct the processors to perform the network analysis and modeling of electronic data described herein. Such embodiments are directed to technological solutions that may involve systems that include, for example, at least one processor coupled to memory and programmed to define a first tier of customers and customer accounts comprising all customer accounts for each of a plurality of initial event case customers; and to define a second tier of customers and customer accounts comprising all customer accounts of each of a plurality of customers having at least one customer account that is a transactional counterparty customer account of at least one of the first tier customer accounts. In addition, the system for embodiments of the invention may include, for example, the processor also being programmed, for example, to define a third tier of customers and customer accounts comprising all customer accounts of each of a plurality of customers having at least one customer account that is a transactional counterparty customer account of at least one of the second tier customer accounts; to identify each of said second tier customers and customer accounts affiliated with an anti-money laundering case history and each of said third tier customers and customer accounts affiliated with an anti-money laundering case history; and to classify each of said first tier customers having no first tier customer accounts with a transactional counterparty customer account link to a second or third tier customer or customer account affiliated with an anti-money laundering case history as a lowest level of financial risk customer.

In aspects of embodiments of the invention, the memory-coupled processor may be further programmed, for example, to receive initial event case data for the plurality of initial event case customers from a case management database. In other aspects, the memory-coupled processor may be further programmed, for example, to correlate the initial event case data for the plurality of initial event case customers received from the case management database to a customer identifier for each of the plurality of initial event case customers based at least in part on a query of the case management database. In still other aspects, the memory-coupled processor may be further programmed, for example, to correlate the customer identifier for each of the plurality of initial event case customers to all customer accounts for each of the plurality of initial event case customers based at least in part on a query of the case management database.

In other aspects of embodiments of the invention, the memory-coupled processor may be further programmed, for example, to query all first tier customer accounts in a case management database for all transactional counterparty customer accounts of each of said first tier customer accounts. In further aspects, the memory-coupled processor may be further programmed, for example, to query all first tier customer accounts in the case management database for all transactional counterparty customer accounts consisting at least in part of monetary instrument transaction or wire transaction counterparty customer accounts of each of said first tier customer accounts. In still further aspects, the memory-coupled processor may be further programmed, for example, to correlate each of said transactional counterparty customer accounts of said first tier customer accounts to customer identifiers for each of said transactional counterparty customer accounts based at least in part on a query of the case management database. In other aspects, the memory-coupled processor may be further programmed, for example, to correlate the customer identifiers for each of said transactional counterparty customer accounts to all accounts of each transactional counterparty customer account customer.

In still other aspects of embodiments of the invention, the memory-coupled processor may be further programmed, for example, to query all second tier customer accounts in a case management database for all transactional counterparty customer accounts of each of said second tier customer accounts. In further aspects, the memory-coupled processor may be further programmed, for example, to query all second tier customer accounts in the case management database for all transactional counterparty customer accounts consisting at least in part of monetary instrument transaction or wire transaction counterparty customer accounts of each of said second tier customer accounts. In still further aspects, the memory-coupled processor may be further programmed, for example, to correlate each of said transactional counterparty customer accounts of each of said second tier customer accounts to customer identifiers for each of said transactional counterparty customer accounts based at least in part on a query of the case management database. In other aspects, the memory-coupled processor may be further programmed, for example, to correlate the customer identifiers for each of said transactional counterparty customer accounts to all accounts of each of said transactional counterparty account customers.

In further aspects of embodiments of the invention, the memory-coupled processor may be further programmed, for example, to generate a query list of all account identifiers and all customer identifiers for all second and third tier customers. In still further aspects, the memory-coupled processor may be further programmed, for example, to query the case management database for anti-money laundering-related case histories affiliated with any of the account identifiers and customer identifiers for all second and third tier customers on the query list. In additional aspects, the memory-coupled processor may be further programmed, for example, to classify each of said first tier customers having no first tier customer accounts with a transactional counterparty customer account link to a third tier customer or customer account and also having no transactional counterparty customer account link to a second tier customer or customer account affiliated with an anti-money laundering case history as a low level of financial risk customer. In other aspects, the memory-coupled processor may be further programmed, for example, to classify each of said first tier customers having at least one first tier customer account with a transactional counterparty customer account link to a second or third tier customer account affiliated with an anti-money laundering case history as a high level of financial risk customer.

Embodiments directed to the technological solutions described herein may also involve a method that includes, for example, defining, by a memory-coupled processor of an entity, a first tier of customers and customer accounts comprising all customer accounts for each of a plurality of initial event case customers; defining, by the memory-coupled processor, a second tier of customers and customer accounts comprising all customer accounts of each of a plurality of customers having at least one customer account that is a transactional counterparty customer account of at least one of the first tier customer accounts; and defining, by the memory-coupled processor, a third tier of customers and customer accounts comprising all customer accounts of each of a plurality of customers having at least one customer account that is a transactional counterparty customer account of at least one of the second tier customer accounts; identifying, by the memory-coupled processor, each of said second tier customers and customer accounts affiliated with an anti-money laundering case history and each of said third tier customers and customer accounts affiliated with an anti-money laundering case history; and classifying, by the memory-coupled processor, each of said first tier customers having no first tier customer accounts with a transactional counterparty customer account link to a second or third tier customer or customer account affiliated with an anti-money laundering case history as a lowest level of financial risk customer.

Aspects of the method for embodiments of the invention may additionally involve, for example, classifying, by the memory-coupled processor, each of said first tier customers having no first tier customer accounts with a transactional counterparty customer account link to a third tier customer or customer account and also having no transactional counterparty customer account link to a second tier customer or customer account affiliated with an anti-money laundering case history as a low level of financial risk customer. Further aspects may involve, for example, classifying, by the memory-coupled processor, each of said first tier customers having at least one first tier customer account with a transactional counterparty customer account link to a second or third tier customer account affiliated with an anti-money laundering case history as a high level of financial risk customer.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

The system may include a process for using machine learning or artificial intelligence to create or correct user tier models. A model may be created of a user based on an input of user histories of interactions, transactions, or other actions. The machine learning system may correct human labels that are mislabeled or incorrect.

The system may include a process for using machine learning or artificial intelligence to analyze each interaction of users and the interactions of each of the second and third tier users. The machine learning system compares the past interactions of users and current interactions to find subtle correlations, trends, or patterns in the interactions to predict which interactions have characteristics of a fraudulent interaction.

The system may include a process for using machine learning or artificial intelligence to analyze interactions in real time as the data is created. When the machine learning system compares the interaction details to other known fraudulent and non-fraudulent interactions, the machine learning system can determine in a period of time, such as 0.5 seconds, whether the interaction is indicative of fraud. This real time speed of the determination allows the decision to be made before the interaction is approved.

The system may include a process for using machine learning or artificial intelligence to create additional tiers of users. For example, a fourth tier that includes all interactions between third tier users and other counter parties may be created. Other tiers may be created such as fifth and sixth tiers, in a similar manner.

This invention represents an advance in computer engineering and a substantial advancement over existing practices. The data acquired to prepare the user models are technical data relating to interactions, geolocations, and other data. The outputs of the machine learning systems are not obtainable by humans or by conventional methods. Creating user models, comparing the models with each other and with multiple tiers of associations, and identifying fraudulent activities using machine learning algorithms is a non-conventional, technical, real-world output and benefit that is not obtainable with conventional systems. A group of humans, no matter how large, could not create the numbers and complexity of the user models, compare the user tiers, analyze each and every interaction between user accounts, and identify the subtle correlations and trends that are observable by the machine learning algorithm. Further, even if this were possible, the analysis could not be performed in real time, such that an interaction could be denied or halted while the interaction is taking place.

### BRIEF DESCRIPTION OF THE DRAWINGS

FIG. 1 is a schematic flow diagram that illustrates an example of the flow of information in the system and for embodiments of the invention; and

FIGS. 2A and 2B show a flow chart that illustrates an overview example of the process for embodiments of the invention.

### DETAILED DESCRIPTION OF THE INVENTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

The model for embodiments of the invention may employ network analytics to determine whether or not there is an influence especially related to financial risk between customers of an entity, such as a financial institution, inside the entity's own internal financial network. In certain examples, the users may be customers of an institution, such as a financial institution. Users and customers may be used interchangeably herein. In certain examples, the fraud may be money laundering or other financial crimes. In other examples, the fraud may be related to any other type of fraud, such as identity theft, unauthorized entry to a physical or digital location, or industrial espionage. The model for embodiments of the invention may employ computer hardware and software, including, without limitation, one or more processors coupled to memory and non-transitory computer-readable storage media with one or more executable computer application programs stored thereon which instruct the processors to perform such network analysis.

The network analysis for embodiments of the invention may not be concerned simply with linkages between customers and/or a manner in which they may be linked to each other, for example, by shared attributes or transactions. Instead, such analysis may be directed to determining whether or not a customer associated with a financial risk concern actually has an influence on another customer or another set of customers using a network effect referred to herein as financial network horizon.

Embodiments of the invention have established that most customers of an entity have influence through only three degrees or steps of the entity's internal financial network. In other words, such embodiments have illustrated that entity customers may have a significant influence on other customers of the entity through only three different association steps from themselves and that a financial network horizon may be reached at three degrees, beyond which their influence becomes negligible. Thus, certain levels of anti-money laundering financial risk may be predicted by embodiments of the invention.

Embodiments of the invention may identify unproductive clients with respect to anti-money laundering (AML) issues that have a propensity to transact in a network with other unproductive or unmonitored clients in a given look-back period. As used herein, an “unproductive” or “unmonitored” client or customer is a customer with a history of an AML case that was not “escalated”, meaning that no financial or money-laundering risk was found in such case. As also used herein, a “productive” client or customer is a customer with a history of an AML case that was deemed to require further investigation.

Further, embodiments of the invention may significantly isolate financial AML risk factors from a majority of a customer population of an entity that represents little-to-no risk or threat. Employment of a model for embodiments of the invention in an analysis for an entity has illustrated that within a transactional network between internal retail customers of the entity, not only is AML risk limited but such risk is also unevenly distributed across the network.

Employment of the model for embodiments of the invention has also determined that not only does such risk affect a small amount of the financial data of the entity, but also takes up an insignificant amount of network capacity. Thus, risk may usually be found at a higher density and is usually isolated from influence on first-time AML-related cases for particular customers, referred to herein as initial event case customers, and their accounts. It has also been found that a lack of connections or connection strength between risk clusters and low or no-risk clusters may be evaluated with a k-core score in social network analytics. The k-core or binding strength numbers may describe how strong a network or cluster within a network is bonded.

The term “initial event case” as used herein refers to an AML-related case that is generated for a particular identification code (ID) of a customer who has never before had such a case arise, no matter how long the particular customer has been a customer of the financial institution. Thus, an initial event case designation is completely devoid, for example, of any reliance on the particular customer's past performance as a potential indicator of future financial risk or any reliance on the customer's connections to one or more other customers with a history of financial risk or a lack of such history. Further, an initial event case also represents the best chance to prove predictive analytic capabilities of the network horizon approach.

Embodiments of the invention provide a computer model for influence decay that evaluates how low risk profiles of initial event case customers may impact the remainder of the customer population from an AIL perspective. In a process for embodiments of the invention, significant numbers of data samples, such as entire monthly segments of data, for initial event case customers or cases may be analyzed based on the financial transaction relationships of those customers with other financial institution customers or counterparties. Thus, in the model for embodiments of the invention, statistically significant sample sizes and entire data sets month by month for multiple months of data may be employed to query and identify initial event case focal IDs normalized to a customer's ID.

The model for embodiments of the invention may result in realized effects in a number of different areas. Thus, millions of dollars may be saved annually in AIL case volume reduction and wasted resources, for example, in terms of computer processing and database resources. For another example, higher risk AML cases may be less obscured by cases with low risk behaviors and patterns resulting in more efficient and effective high-risk case analysis. In addition, financial AML risk factors may be significantly isolated from a majority of a customer population of an entity, such as a financial institution, that represents little-to-no risk or threat.

In embodiments of the invention, each customer of the financial institution may be assigned a customer ID code, and one or more AML-related cases may relate, for example, to anomalous activity associated with an ID code of a particular customer. These AML-related cases may be generated, for example, based on identification of anomalous behavior by the financial institution's AML monitoring systems. The customer's ID may then be correlated to all existing accounts, and those accounts may be queried for their counterparties to identify customers in a second tier of a network for embodiments of the invention. Thereafter, case histories, if any, for all of such second tier customers or counterparties may be analyzed. This process not only synchronizes the analysis for customers that may have cases on other identification codes, but codifies a need for overall identity resolution.

In embodiments of the invention, initial event case customers may be designated as a first tier, and their first transactional relationships with such counterparties may be designated a second tier of a network. The counterparties in the second tier of the network may likewise be analyzed based on the financial transaction relationships of those second tier counterparty customers with still other financial institution customers or counterparties, which may be designated as a third tier of the network. The second tier accounts may then be correlated to their customer IDs, and then re-correlated with their corresponding accounts to generate a full complement of accounts affiliated with customers in the second tier of the network.

The second tier accounts may then be queried for transactional account relationships with their counterparties, which become nodes in a third tier of the network. Those transactional account relationships may then be correlated to related customer IDs, and all accounts corresponding to such customer IDs may be identified. Thus, the third tier accounts may be correlated to their customer IDs, and then re-correlated with corresponding accounts to generate a full complement of accounts affiliated with customers in the third tier of the network.

In embodiments of the invention, a list of second and third tier account and customer IDs may be used as a focal ID query list for AML case histories, and the IDs of affiliated AML cases with case status information may be correlated and studied. If an initial event case customer can be traced from the first tier through the second tier to the third tier without being linked to a customer or account affiliated with a productive affiliated case, the initial event case customer may be evaluated as a lowest risk to the rest of the customer population.

Initial event case customers that do not have a network affiliation with a productive customer in the second tier and do not correlate to any account in the third tier in the network may also be considered a low risk and may be included as a low risk to the rest of the customer population. However, initial event case customers that are connected to a productive counterparty may remain in the AML case population for analysis. A productive counterparty may be defined as a counterparty customer in the second or third tier affiliated with a case status that indicates escalation or that a suspicious activity report (SAR) was filed.

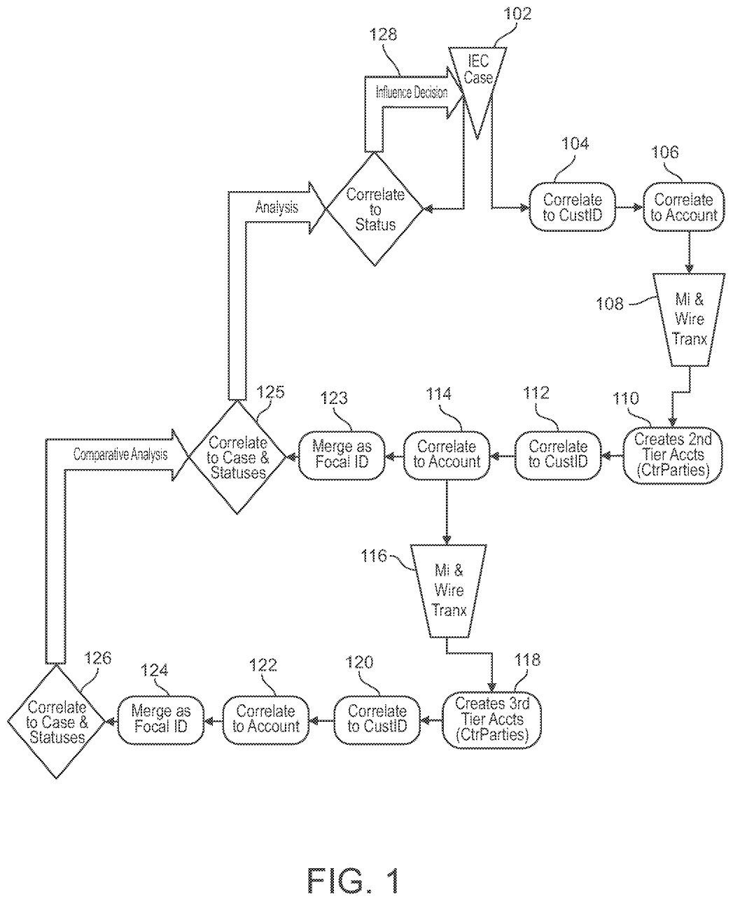

FIG. 1 is a schematic flow chart that illustrates an example of the flow of information in the system for embodiments of the invention. Referring to FIG. 1, at 102, in a first tier customer aspect, initial event case data may be received by a memory-coupled processor of an entity server from a case management database that may collect and store all AML-related data for an entity. The received data may consist at least in part of customer IDs for one or more initial event case customers. At 104, the initial event case data may be correlated by the processor to a customer ID for at least one initial event case customer based on a query of the case management database.

Referring further to FIG. 1, at 106, the initial event case customer ID may be correlated to all existing entity accounts of the initial event case customer by the processor based on a query of the case management database. For example, the received data consisting at least in part of the initial event case customer's ID may be correlated with data, such as account information of the client and selected client attributes, related to all of the initial event case customer's accounts retrieved from the AML case management database. In addition, the initial event case customer's ID and account data may be correlated with data regarding an initial set of transactions retrieved from the case management database to identify other cases, if any, that may have arisen in the first tier.

Referring again to FIG. 1, at 108, the existing accounts of the initial event case customer in the case management database may be queried for accounts of counterparties, for example, of monetary instruments and wire transactions associated with the initial event case customer's existing accounts. For example, based on the correlation of customer ID and account information, all of the initial event case customer's accounts may traced, for example, via monetary instruments such as checks and transactions such as wire transactions over a predetermined period of time or look-back period, such as 90 days or 180 days, to accounts of other customers of the entity. It has been found that the particular look-back periods of 90 or 180 days typically yields non-productive customers in 84% to 92% of cases processed, but it is to be understood that the look-back period is not limited to 90 or 180 days but may cover any other suitable period of time.

Referring still further to FIG. 1, at 110, in a second tier customer aspect, a second tier comprising the accounts of counterparties or second tier customers, for example, of monetary instruments and wire transactions associated with an initial event case customer's existing accounts may be created by the processor. At 112, the accounts of the second tier customers may be correlated to customer IDs of second tier customers by the processor based on a query of the case management database. At 114, the customer IDs of the second tier customers may be correlated to all existing accounts of the second tier customers by the processor based on a query of the case management database.

The identifications of such second tier customers, which may be referred to herein as focal IDs, may likewise be correlated with data, such as account information and selected attributes, for such other customers retrieved from the case management database. Thus, all such customers with AML-related cases who are directly connected to a particular initial event case customer may be identified. An identifier at either the customer level or an account level that is found in the case management database which identifies a focal ID or an identification of the focus for a particular initial event case may be merged in the case management database. The focal ID may be correlated with any account cases and/or case statuses previously escalated or developed by AML analysis and were deemed productive, and such cases may thus be identified. As noted, any cases which were determined to have relatively little or no risk potential may be deemed unproductive.

Referring once again to FIG. 1, at 116, the existing accounts of the second tier customers may be queried for accounts of counterparties, for example, of monetary instruments and wire transactions associated with the second tier customers' existing accounts by the processor based on a query of the case management database. Based on the correlation of focal IDs and account information, all accounts associated with the focal IDs may likewise be traced, for example, to monetary instruments such as checks and transactions such as wire transactions over the predetermined period of time or look-back period. Thus, any cases and/or case statuses that may have been previously escalated or developed by AML analysis and are thus deemed productive may also be identified. The customer ID to which correlations are made is the identifier assigned by the entity to a particular customer. The correlation of a customer's ID to accounts and transactions may refer, for example, to accounts on which the particular customer's ID appears.

Referring once again to FIG. 1, at 118, in a third tier customer aspect, a third tier comprising the accounts of counterparties, for example, of monetary instruments and wire transactions associated with the second tier customers' existing accounts may be created by the processor. At 120, the accounts of the third tier customers may be correlated to customer IDs of the third tier customers by the processor based on a query of the case management database. At 122, the customer IDs of the third tier customers may be correlated to all existing accounts of the third tier customers by the processor based on a query of the case management database.

Referring also to FIG. 1, at 123 and 124, respectively, a query list may be generated for all account and customer IDs for all second and third tier customers by the processor. At 125 and 126, respectively, the case management database may be queried for all AML related case histories related to any of the account and customer IDs for the second and third tier customers on the query list by the processor.

Referring once more to FIG. 1, at 128, when the query at 125 and 126 returns no AML related case histories related to any of the account and customer IDs for second and third tier customers the initial event case customer may be deemed a lowest risk to a customer population of the entity. Also at 128, when the query at 116 returns no accounts of counterparties, for example, of monetary instruments and wire transactions associated with the second tier customers' existing accounts by the processor and the query at 126 returns no AML related case histories related to any of the account and customer IDs for the second tier customers, the initial event case customer may be deemed a low risk to customer population of the entity. However, when the query at 125 and 126 returns one or more AML related case histories related to any of the account and customer IDs for second and third tier customers, the initial event case customer may be deemed a risk to the customer population of the entity and remain in an AML population for analysis.

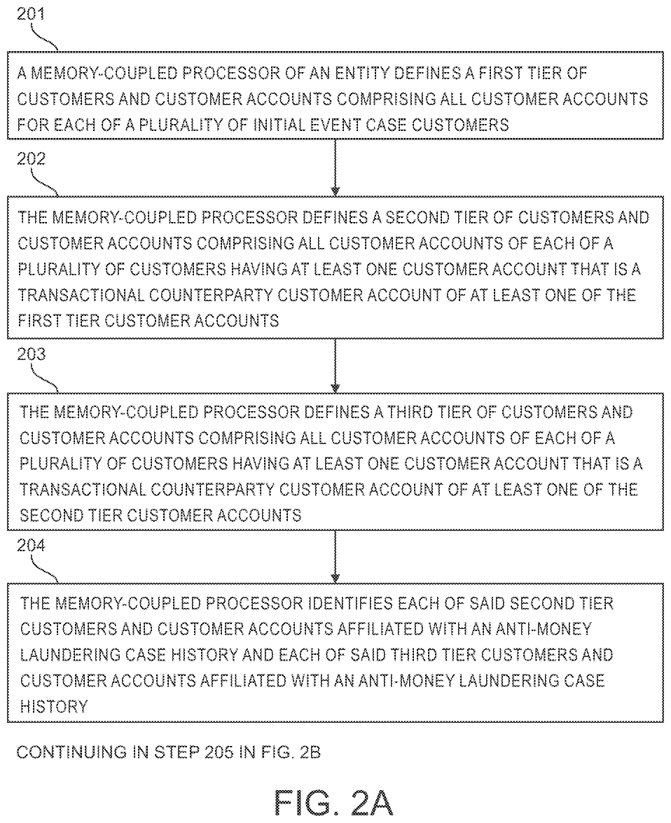

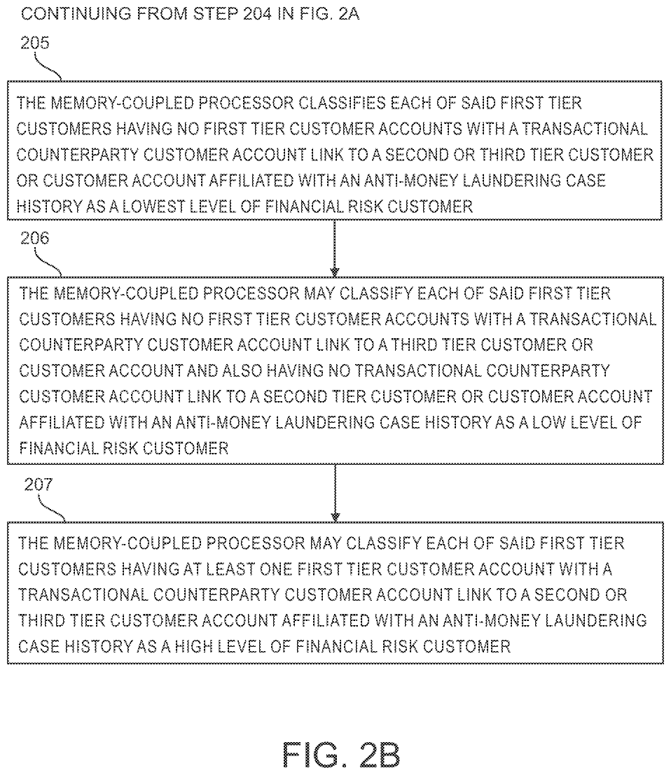

FIGS. 2A and 2B show a flow chart that illustrates an example of the process for embodiments of the invention. Referring to FIG. 2A, at 201, a memory-coupled processor of an entity may define a first tier of customers and customer accounts comprising all customer accounts for each of a plurality of initial event case customers. At 202, the memory-coupled processor may define a second tier of customers and customer accounts comprising all customer accounts of each of a plurality of customers having at least one customer account that is a transactional counterparty customer account of at least one of the first tier customer accounts. At 203, the memory-coupled processor may define a third tier of customers and customer accounts comprising all customer accounts of each of a plurality of customers having at least one customer account that is a transactional counterparty customer account of at least one of the second tier customer accounts. At 204, the memory-coupled processor may identify each of said second tier customers and customer accounts affiliated with an anti-money laundering case history and each of said third tier customers and customer accounts affiliated with an anti-money laundering case history.

Referring to FIG. 2B, at 205, the memory-coupled processor may classify each of said first tier customers having no first tier customer accounts with a transactional counterparty customer account link to a second or third tier customer or customer account affiliated with an anti-money laundering case history as a lowest level of financial risk customer. At 206, the memory-coupled processor may classify each of said first tier customers having no first tier customer accounts with a transactional counterparty customer account link to a third tier customer or customer account and also having no transactional counterparty customer account link to a second tier customer or customer account affiliated with an anti-money laundering case history as a low level of financial risk customer. At 207, the memory-coupled processor classifies each of said first tier customers having at least one first tier customer account with a transactional counterparty customer account link to a second or third tier customer account affiliated with an anti-money laundering case history as a high level of financial risk customer.

As noted, a correlation between a customer's ID and monetary instruments and wire transactions may refer, for example, to checks and wire transactions on which the particular customer's ID appears. At the second tier, other customer's accounts whose customers' IDs appear in transactions with a customer in the first tier are identified and traced back in the same way as the initial event customer in the first tier. Thus, in addition to simply uncovering information about transactions between the initial event customer and customers in the second tier, embodiments of the invention provide information about the second tier customers and their accounts and transactions, and the same is true for customers in the third tier.

The process for embodiments of the invention may provide an understanding of entity customers across their accounts and customer IDs and case dispositions, if any, and a level of influence such customers may have not only on an initial event case customer but on other customers as well. Customer accounts identified in the process may be analyzed to identify all customers with whom those customers transacted within a pre-determined period of time. As noted, such period of time, which may be referred to as a “look-back” period, may be determined based, for example, on a particular type of case that may be under investigation and may typically be a period of 90 days to 180 days.

In embodiments of the invention, once a third tier of transactional linkages, and a fourth degree if desired, are identified, a search may be performed for case histories of all customers identified as having transactional linkages during the selected look-back period, such as 90 days to 180 days. The network of transactional linkages may then be traced back to the initial event case customer. From an AML perspective, it has been found that an initial event case customer typically represents a very low financial risk and usually transacts only with other customers of low financial risk. It has also been found that any high financial risk represents a small percentage of the potential risks within the greater network and is usually isolated and not evenly dispersed. Further, it has been found that low risk profiles of 84% to 92% of all initial event case customers may be predicted.

Embodiments of the invention may be useful, for example, in reducing case volume or in accurately working through unproductive case volume more quickly and efficiently which translates to reduced processing time and expense and increased efficiency, as well as a reduction of negative impact on operations. Thus, embodiments of the invention may be implemented to enhance base category AML case allocation, resulting in significant cost-per-case savings. Such implementation may not require updated technology or monitoring solutions.

Embodiments of the invention may provide computer logic that can be incorporated in existing models that suppresses low productivity case generation and may also provide an attribute or statistical event generation model. Such embodiments may be implemented via one or more computer models that perform an analysis process, for example, on a monthly basis for all new AML cases. The one or more models for this process may be integrated in other models or processes within an entity to greatly improve the way in which worthwhile or quality AML cases are generated, analyzed and produced.

A model for embodiments of the invention may, for example, identify entity customers on a monthly basis that have never previously had a case and are thus deemed initial event case customers. The model may then identify the counterparties of such customer or second tier customers of a network and the counterparties of the second tier customers or third tier customers of the network. Thereafter, the model may search for case histories and trace back through the network to determine whether or not an initial event customer has financial linkages to one or more other customers with a productive or risky case history. The model for embodiments of the invention may output, for example, a risk score.

For example, such model may evaluate the linkages between customers of little or no productivity and customers of high productivity and generate a score based on a context of those linkages and how often and/or how regularly they occur. The more likely the influence a high-risk customer may have on an initial event customer, the higher the score may be. Embodiments of the invention may involve a pre-defined threshold score corresponding to a likelihood that such influence is deemed worthy of investigation. Scores falling above the threshold may, for example, lead to generation of an alert or notification regarding a particular initial event customer.

In embodiments of the invention, based on the foregoing correlations, risk values may be assigned at each level as the process moves through each tier, and a total risk score value may be calculated for the initial event case. Such total risk score value may provide a measure of whether a particular initial case customer presents a low level of risk or a high level of risk. It is to be understood, however, that the total score represents a measure of the influence that one or more high-risk customers may have on the initial event customers and is thus an indirect indicator of a risk level for the initial event case customer. Embodiments of the invention may also provide a predictive model based on analytics applied to connections such as transactions and attributes, for example, to perform influence mapping rather than simply identifying such connections between customers.

### Creating and Correcting User Tier Models

In an example, a machine learning system may be employed to create and/or correct user tier models. A model may be created of a user based on an input of user histories of interactions, transactions, or other actions. The machine learning system may be any machine learning or artificial intelligence function of the memory-coupled processor, such as a software component of the memory-coupled processor, a hardware logically connected to the memory-coupled processor, or any other function, process, algorithm, or application.

The process of creating the model is performed automatically by the machine learning system without human intervention, as described in the Machine Learning section below.

Because the model creation and correction are performed by the machine learning system based on data collected by the data acquisition system, human analysis or cataloging is not required. The process is performed automatically by the machine learning system without human intervention, as described in the Machine Learning section below. The amount of data typically collected from the entities, institutions, the third-party providers, and the other data sources may include thousands to tens of thousands of data items for each user. The total number of users may include all of a financial institution's clients, all of a cellular provider's clients, all of the users on a social network, or the users from any other third-party provider. Human intervention in the process is not useful or required because the amount of data is too great. A team of humans would not be able to catalog or analyze the data in any useful manner to create user models as described.

As described herein, the received user data may include the tiers of other users with which the user has had interactions. For example, a first tier of users includes users to be analyzed. A second tier of users includes all the users with which each first tier user has had interactions. A third tier is formed of users with which the second tier of users has had interactions.

In the examples described herein, such as in FIGS. 2A and 2B, some aspects of user tiers may be created or assigned by a human based on a limited amount of data. Human-entered data into the tiers may include errors, omissions, or simply incomplete connections. For example, humans may label certain interactions as fraudulent based on data received from a counterparty or institution. While humans are unable to create the complete user models, certain data in the models may be provided by humans.

The number of users in the first tier may include all of the users of the entity associated with the machine learning system. For example, each of the users of a social media entity may comprise the first tier. This tier may include many millions of users. In another example, the users each of the users of a financial institution, such as a bank or credit card company, may comprise the first tier. In another example, each of the users of an online marketplace may comprise the first tier.

The second tier may include every user with which the user has interacted. This may include many thousands of users of a social media entity with which the user has interacted, or the many thousands of users with which the user has conducted a transaction. The third tier may include the many thousands of users with which each of the second tier users have interacted. The total number of users in the third tier may be in the many millions of users. The quantity of data from this number of users requires a complex and powerful memory-coupled processor.

The machine learning system analyzes the user data. The user data may include the details of each interaction of the user with other users in the second tier. The machine learning system may use the user data to create models of the users and the user tiers or to correct and improve the human-created tiers.

In an example, the machine learning system is used to correct human errors when assigning connection tiers or with labeling of interactions. The machine learning system identifies and corrects errors made by the humans by comparing the textual data with the assigned labels. The machine learning system may employ techniques, such as Natural Language Processing (NLP) and deep neural networks.

These types of algorithms or processes may be used for analyzing textual data associated with the user accounts and interactions. This textual data might include transaction descriptions, notes, or other narrative elements associated with each user or interaction. Machine learning models trained on this textual data can extract meaningful information, detect hidden relationships, and identify potential discrepancies that are missed by the humans. For instance, if human errors were made when assigning connection tiers or risk levels, NLP models could identify and correct these errors by comparing the textual data with the assigned labels.

The machine learning system may be used to identify and correct human labeling or identification of fraudulent interactions or users. For example, if a human analyst has incorrectly labelled a user or interaction, or failed to identify a fraudulent user or interaction, a machine learning algorithm can be used to identify the error and correct the labels.

Each interaction may include data associated with a transaction or other type of interaction. The data may include notifications of fraudulent activity. The data may not include direct notifications of fraudulent activity, but instead include only characteristics or indications of fraudulent activity. In other examples, fraudulent activity may not be indicated at all, but the circumstances of the interaction may provide a subtle correlation with fraudulent activity that is not observable by a human or not observable without a tremendous amount of comparison data.

Machine learning system algorithms, such as NLP techniques and deep neural networks can be applied to analyze textual data associated with the accounts and interactions. This textual data might include transaction descriptions, notes, or other narrative elements. Machine learning models trained on this textual data can extract meaningful information, detect hidden relationships, and identify potential discrepancies.

In another example, the machine learning system creates a model of the user based on the user data. The model may use the vast amount of user data from other users to help shape the model. For example, the actions of other users with similar characteristics may be accessed to help build a prediction model of actions of the present user.

The machine learning system may create a model for each first-tier user. The machine learning system continually receives inputs of the actions of each first-tier user and the respective second and third tier users of each first-tier user. The machine learning system continually updates the models of the users.

The machine learning system compares the predictive models of each user to find subtle correlations, trends, or patterns in the models to predict which users are more likely at risk of committing a fraudulent interaction. For example, if a user with certain characteristics that are not normally associated with fraud, performs a fraudulent interaction, then the machine learning system may recognize that other users with similar characteristics have also performed a similar fraudulent interaction.

The characteristic may be seemingly innocent, such as a geographic location of a user residence, a type of job, or a particular educational background. The machine learning system recognizes that a pattern has emerged that users with this particular set of characteristics have a higher-than-expected number of fraudulent actions.

With this knowledge, the machine learning system is able to perform an action relative to other users with this characteristic, such as slightly raising risk scores, more closely observing future interactions, notifying a fraud operator, denying associated interactions, or any other suitable action.

The comparison of each user model allows the machine learning system to more accurately predict which users will be more likely to commit or attempt fraudulent interactions.

### Interaction Analysis

The machine learning system may further analyze each interaction of users and the interactions of each of the second and third tier users. The machine learning system logs characteristics of each interaction, such as the location of the counterparties, the value of the interaction, objects being exchanged, payment methods, length of interactions, time and date of interaction, or any other suitable data.

The machine learning system compares the past interactions of users and current interactions to find subtle correlations, trends, or patterns in the interactions to predict which interactions have characteristics of a fraudulent interaction. For example, if an interaction with certain characteristics that are not normally associated with fraud, does receive a label of fraud from a human, third party, or other labeler, then the machine learning system may recognize that other interactions with similar characteristics may similarly have fraudulent components.

Machine learning algorithms can be used to identify the riskiness of these interactions at a more granular level, based on data such as the counterparties involved in transactions, transaction times (such as the time of day or week that transactions occur or the geographic location of the counterparties), transaction details (textual information), transaction size, frequency of repeat interactions, or any other granular details of the transaction.

The riskiness of these interactions may be identified by training a machine learning process on a dataset of historical transactions that have been labelled as fraudulent and non-fraudulent. By training on past examples, the algorithms develop the ability to recognize patterns that indicate potential risks, even if the patterns are not distinct enough to be observable by a human. As a result, the machine learning system can assign risk scores to accounts based on a combination of these factors. This process allows for a more accurate and nuanced understanding of each interaction's level of risk.

In an example, an interaction between a user in one geographic location is conducted with a user in a second geographic location. While either location alone is not indicative of fraud, the combination of the two locations may be identified by the machine learning system as being associated with other fraudulent interactions. In another example, a user performs a series of low value transactions with another user. Each transaction alone is not indicative of fraud, but the series of transactions may be identified by the machine learning system as being associated with fraud when the total number of transactions becomes greater than a threshold. Any other non-observable fraud indicators may be identified by the machine learning system based on the analysis of historic data and the analysis of current users and user transactions to identify unseen, subtle trends, correlations, or connections.

### Account Clustering

The machine learning system can group together accounts that exhibit similar behaviors and interaction patterns. For example, the machine learning system may cluster lowest risk and low risk accounts together into a cluster or group. Accounts within the same cluster are expected to follow the norm and display consistent behavior.

The clusters may be based on actual user labels and designations or based on the created user models as described in the Creating and Correcting User Tier Models section above. For example, after a user data has been analyzed and a user model is created, the user model may be clustered with other user models that have similar characteristics.

The machine learning system may monitor and compare the behaviors of each of the user models in each cluster. For example, a user may be in a cluster of accounts that have characteristics of a user under 30 years old, with an account younger than one year old, a location in the southwestern United States, in a rural area, with an education level of college degree or above. The user in this cluster would be expected to have interactions that are similar to other users in this cluster, with similar rates of fraud and with similar risk scores.

The machine learning system may recognize interactions from a user in the cluster that deviate from the expected cluster behavior. An individual user that deviates from expected cluster behavior may be flagged for human review. For example, a user in the cluster described above begins to have multiple transactions overseas during the middle of the night. In another example, a user in the cluster described above begins to conduct interactions with a type of payment instrument that is atypical for the cluster. When these atypical interactions occur, the user may be flagged for a risk assessment or for a human intervention.

In another example, an entire cluster of accounts begins to conduct interactions that do not fit the expected pattern of interactions. For example, a cluster of users suddenly begin conducting large, suspicious transactions, the machine learning system may trigger a red flag for a risk reassessment. Based on the new types of transactions, the cluster may no longer be considered low risk, but are elevated to a higher risk category.

### Real Time Analysis

The machine learning system may analyze interactions in real time as the data is created. The machine learning system provides an analysis generally as described in the Interaction Analysis section above. However, the analysis is performed on an interaction in real time to allow the machine learning system to identify fraudulent interactions in time to disallow or reject a pending interaction.

For example, if an interaction is a request to enter a secure location, the request may be denied based on the analysis. In another example, if an interaction is a transaction, the transaction may be rejected before payment is complete based on the analysis.

The machine learning system receives the details of a proposed interaction in real time as the interaction details are being entered by the users. For example, if a user is entering credentials to be allowed access to a digital file, the entered credentials are communicated to the machine learning system. Based on the user models, the machine learning system may analyze the interaction inputs to determine if the interaction has an indication of fraud.

The machine learning system may analyze specific details of the interaction for comparison to other interactions and other users. Details may include characteristics such as a user identity, location of the user and the counterparty, time of day, amount of the interaction, elapsed time since the last interaction, distributed fraud alerts associated with the type of interaction, entry errors by either counterparty, or any other characteristics.

When the machine learning system compares the interaction details to other known fraudulent and non-fraudulent interactions, the machine learning system can determine in a period of time, such as 0.5 seconds, whether the interaction is indicative of fraud. This real time speed of the determination allows the decision to be made before the interaction is approved or disapproved. Without the processing speed of the machine learning system, the interaction would either not be approved in any useful time, or the interaction would have to proceed without an approval.

### Additional Tiers

Because of the significant processing and storage capacity of a machine learning system, additional tiers of users may be created and analyzed. As described in the Creating and Correcting User Tier Models section above, three tiers are analyzed for each user. However, the machine learning system may create and analyze additional tiers for each user. For example, a fourth tier that includes all interactions between third tier users and other counter parties may be created. Other tiers may be created such as fifth and sixth tiers, in a similar manner.

By creating additional tiers, more subtle connections, correlations, patterns, or trends may be identified by the machine learning system. With each additional tier, potentially millions more interactions are available for analysis. The additional interactions allow more connections to be drawn between fraudulent interactions and the characteristics of each user and interaction.

### Machine Learning

Machine learning is a field of study within artificial intelligence that allows computers to learn functional relationships between inputs and outputs without being explicitly programmed.

The term “Artificial Intelligence” refers to a quantitative method, system, or approach (“techniques”) that emulates human intelligence via computer programs. These can be used to make estimates, predictions, recommendations, or decisions in manners that go beyond classical, statistical, mathematical, econometric, or financial approaches.

Machine learning is the subset of AI that derives representations or inferences from data without explicitly programming every parameter representation or computer step (for example, Random Forest or Artificial Neural Network based algorithm approaches). In contrast, AI techniques that are not members of the machine learning subset include techniques such as fuzzy logic, complex dependency parsing techniques for natural language processing.

Machine learning involves a module comprising algorithms that may learn from existing data by analyzing, categorizing, or identifying the data. Such machine-learning algorithms operate by first constructing a model from training data to make predictions or decisions expressed as outputs. In example embodiments, the training data includes data for one or more identified features and one or more outcomes, for example using user purchasing histories and geolocations to offer real-time incentives for purchases with a payment instrument to an identified high spend event to users likely to switch payment instruments. Although example embodiments are presented with respect to a few machine-learning algorithms, the principles presented herein may be applied to other machine-learning algorithms.

Data supplied to a machine learning algorithm can be considered a feature, which can be described as an individual measurable property of a phenomenon being observed. The concept of feature is related to that of an independent variable used in statistical techniques such as those used in linear regression. The performance of a machine learning algorithm in pattern recognition, classification and regression is highly dependent on choosing informative, discriminating, and independent features. Features may comprise numerical data, categorical data, time-series data, strings, graphs, or images.

In general, there are two categories of machine learning problems: classification problems and regression problems. Classification problems, also referred to as categorization problems, aim at classifying items into discrete category values. Training data teaches the classifying algorithm how to classify. In example embodiments, features to be categorized may include transaction data, which can be provided to the classifying machine learning algorithm and then placed into categories of, for example, transactions with payment instrument X, transactions at geolocation Y, or incentives provided that prompted a change in payment instrument. Regression algorithms aim at quantifying and correlating one or more features. Training data teaches the regression algorithm how to correlate the one or more features into a quantifiable value.

### Embedding

In one example, the machine learning module may use embedding to provide a lower dimensional representation, such as a vector, of features to organize them based off respective similarities. In some situations, these vectors can become massive. In the case of massive vectors, particular values may become very sparse among a large number of values (e.g., a single instance of a value among 50,000 values). Because such vectors are difficult to work with, reducing the size of the vectors, in some instances, is necessary. A machine learning module can learn the embeddings along with the model parameters. In example embodiments, features such as geolocation can be mapped to vectors implemented in embedding methods. In example embodiments, embedded semantic meanings are utilized. Embedded semantic meanings are values of respective similarity. For example, the distance between two vectors, in vector space, may imply two values located elsewhere with the same distance are categorically similar. Embedded semantic meanings can be used with similarity analysis to rapidly return similar values. In example embodiments, the methods herein are developed to identify meaningful portions of the vector and extract semantic meanings between that space.

### Training Methods

In example embodiments, the machine learning module can be trained using techniques such as unsupervised, supervised, semi-supervised, reinforcement learning, transfer learning, incremental learning, curriculum learning techniques, and/or learning to learn. Training typically occurs after selection and development of a machine learning module and before the machine learning module is operably in use. In one aspect, the training data used to teach the machine learning module can comprise input data such as user interaction histories and the respective target output data such as whether a user is likely to conduct a fraudulent interaction.

### Unsupervised and Supervised Learning

In an example embodiment, unsupervised learning is implemented. Unsupervised learning can involve providing all or a portion of unlabeled training data to a machine learning module. The machine learning module can then determine one or more outputs implicitly based on the provided unlabeled training data. In an example embodiment, supervised learning is implemented. Supervised learning can involve providing all or a portion of labeled training data to a machine learning module, with the machine learning module determining one or more outputs based on the provided labeled training data, and the outputs are either accepted or corrected depending on the agreement to the actual outcome of the training data. In some examples, supervised learning of machine learning system(s) can be governed by a set of rules and/or a set of labels for the training input, and the set of rules and/or set of labels may be used to correct inferences of a machine learning module.

### Semi-Supervised and Reinforcement Learning

In one example embodiment, semi-supervised learning is implemented. Semi-supervised learning can involve providing all or a portion of training data that is partially labeled to a machine learning module. During semi-supervised learning, supervised learning is used for a portion of labeled training data, and unsupervised learning is used for a portion of unlabeled training data. In one example embodiment, reinforcement learning is implemented. Reinforcement learning can involve first providing all or a portion of the training data to a machine learning module and as the machine learning module produces an output, the machine learning module receives a “reward” signal in response to a correct output. Typically, the reward signal is a numerical value and the machine learning module is developed to maximize the numerical value of the reward signal. In addition, reinforcement learning can adopt a value function that provides a numerical value representing an expected total of the numerical values provided by the reward signal over time.

### Transfer Learning

In one example embodiment, transfer learning is implemented. Transfer learning techniques can involve providing all or a portion of a first training data to a machine learning module, then, after training on the first training data, providing all or a portion of a second training data. In example embodiments, a first machine learning module can be pre-trained on data from one or more computing devices. The first trained machine learning module is then provided to a computing device, where the computing device is intended to execute the first trained machine learning model to produce an output. Then, during the second training phase, the first trained machine learning model can be additionally trained using additional training data, where the training data can be derived from kernel and non-kernel data of one or more computing devices. This second training of the machine learning module and/or the first trained machine learning model using the training data can be performed using either supervised, unsupervised, or semi-supervised learning. In addition, it is understood transfer learning techniques can involve one, two, three, or more training attempts. Once the machine learning module has been trained on at least the training data, the training phase can be completed. The resulting trained machine learning model can be utilized as at least one of trained machine learning module.

### Incremental and Curriculum Learning

In one example embodiment, incremental learning is implemented. Incremental learning techniques can involve providing a trained machine learning module with input data that is used to continuously extend the knowledge of the trained machine learning module. Another machine learning training technique is curriculum learning, which can involve training the machine learning module with training data arranged in a particular order, such as providing relatively easy training examples first, then proceeding with progressively more difficult training examples. As the name suggests, difficulty of training data is analogous to a curriculum or course of study at a school.

### Learning to Learn

In one example embodiment, learning to learn is implemented. Learning to learn, or meta-learning, comprises, in general, two levels of learning: quick learning of a single task and slower learning across many tasks. For example, a machine learning module is first trained and comprises of a first set of parameters or weights. During or after operation of the first trained machine learning module, the parameters or weights are adjusted by the machine learning module. This process occurs iteratively on the success of the machine learning module. In another example, an optimizer, or another machine learning module, is used wherein the output of a first trained machine learning module is fed to an optimizer that constantly learns and returns the final results. Other techniques for trainingth machine learning module and/or trained machine learning module are possible as well.

### Contrastive Learning

In example embodiment, contrastive learning is implemented. Contrastive learning is a self-supervised model of learning in which training data is unlabeled is considered as a form of learning in-between supervised and unsupervised learning. This method learns by contrastive loss, which separates unrelated (i.e., negative) data pairs and connects related (i.e., positive) data pairs. For example, to create positive and negative data pairs, more than one view of a datapoint, such as rotating an image or using a different time-point of a video, is used as input. Positive and negative pairs are learned by solving dictionary look-up problem. The two views are separated into query and key of a dictionary. A query has a positive match to a key and negative match to all other keys. The machine learning module then learns by connecting queries to their keys and separating queries from their non-keys. A loss function, such as those described herein, is used to minimize the distance between positive data pairs (e.g., a query to its key) while maximizing the distance between negative data points. See e.g., Tian, Yonglong, et al. “What makes for good views for contrastive learning?” Advances in Neural Information Processing Systems 33 (2020): 6827-6839.

### Pre-Trained Learning

In example embodiments, the machine learning module is pre-trained. A pre-trained machine learning model is a model that has been previously trained to solve a similar problem. The pre-trained machine learning model is generally pre-trained with similar input data to that of the new problem. A pre-trained machine learning model further trained to solve a new problem is generally referred to as transfer learning, which is described herein. In some instances, a pre-trained machine learning model is trained on a large dataset of related information. The pre-trained model is then further trained and tuned for the new problem. Using a pre-trained machine learning module provides the advantage of building a new machine learning module with input neurons/nodes that are already familiar with the input data and are more readily refined to a particular problem. See e.g., Diamant N, et al. Patient contrastive learning: A performant, expressive, and practical approach to electrocardiogram modeling. PLoS Comput Biol. 2022 Feb. 14; 18(2):e1009862.

In some examples, after the training phase has been completed but before producing predictions expressed as outputs, a trained machine learning module can be provided to a computing device where a trained machine learning module is not already resident, in other words, after training phase has been completed, the trained machine learning module can be downloaded to a computing device. For example, a first computing device storing a trained machine learning module can provide the trained machine learning module to a second computing device. Providing a trained machine learning module to the second computing device may comprise one or more of communicating a copy of trained machine learning module to the second computing device, making a copy of trained machine learning module for the second computing device, providing access to trained machine learning module to the second computing device, and/or otherwise providing the trained machine learning system to the second computing device. In example embodiments, a trained machine learning module can be used by the second computing device immediately after being provided by the first computing device. In some examples, after a trained machine learning module is provided to the second computing device, the trained machine learning module can be installed and/or otherwise prepared for use before the trained machine learning module can be used by the second computing device.

After a machine learning model has been trained it can be used to output, estimate, infer, predict, generate, produce, or determine, for simplicity these terms will collectively be referred to as results. A trained machine learning module can receive input data and operably generate results. As such, the input data can be used as an input to the trained machine learning module for providing corresponding results to kernel components and non-kernel components. For example, a trained machine learning module can generate results in response to requests. In example embodiments, a trained machine learning module can be executed by a portion of other software. For example, a trained machine learning module can be executed by a result daemon to be readily available to provide results upon request.

In example embodiments, a machine learning module and/or trained machine learning module can be executed and/or accelerated using one or more computer processors and/or on-device co-processors. Such on-device co-processors can speed up training of a machine learning module and/or generation of results. In some examples, trained machine learning module can be trained, reside, and execute to provide results on a particular computing device, and/or otherwise can make results for the particular computing device.

Input data can include data from a computing device executing a trained machine learning module and/or input data from one or more computing devices. In example embodiments, a trained machine learning module can use results as input feedback. A trained machine learning module can also rely on past results as inputs for generating new results. In example embodiments, input data can comprise interaction histories and, when provided to a trained machine learning module, results in output data such as users that are likely to perform fraudulent interactions. The output can then be provided to the incentive system to use in determining what incentives to offer to certain users. As such, the identification-related technical problem of determining when a user that is likely to change payment instruments is at a high spend event can be solved using the herein-described techniques that utilize machine learning to produce outputs of when high spend events are occurring, what users should be targeted, and what incentives should be provided.

### Algorithms

Different machine-learning algorithms have been contemplated to carry out the embodiments discussed herein. For example, linear regression (LiR), logistic regression (LoR), Bayesian networks (for example, naive-bayes), random forest (RF) (including decision trees), neural networks (NN) (also known as artificial neural networks), matrix factorization, a hidden Markov model (HMM), support vector machines (SVM), K-means clustering (KMC), K-nearest neighbor (KNN), a suitable statistical machine learning algorithm, and/or a heuristic machine learning system for classifying or evaluating whether a user is likely to conduct a fraudulent interaction.

The methods described herein can be implemented with more than one machine learning method. The machine learning system can use a combination of machine learning algorithms. The machine learning algorithms may be of the same type or of different types. For example, a first machine learning algorithm may be trained for a first type of result, while a second machine learning algorithm may be trained for a second type of result. In certain examples, the first type of result may be an input into the second machine learning algorithm, while in other examples, the two results are combined to produce a third result. In certain examples, the first and second types of results are both inputs into a third machine learning algorithm that produces the third result.

### Linear Regression (LiR)

In one example embodiment, linear regression machine learning is implemented. LiR is typically used in machine learning to predict a result through the mathematical relationship between an independent and dependent variable. A simple linear regression model would have one independent variable (x) and one dependent variable (y). A representation of an example mathematical relationship of a simple linear regression model would be y=mx+b. In this example, the machine learning algorithm tries variations of the tuning variables m and b to optimize a line that includes all the given training data.

The tuning variables can be optimized, for example, with a cost function. A cost function takes advantage of the minimization problem to identify the optimal tuning variables. The minimization problem preposes the optimal tuning variable will minimize the error between the predicted outcome and the actual outcome. An example cost function may comprise summing all the square differences between the predicted and actual output values and dividing them by the total number of input values and results in the average square error.

To select new tuning variables to reduce the cost function, the machine learning module may use, for example, gradient descent methods. An example gradient descent method comprises evaluating the partial derivative of the cost function with respect to the tuning variables. The sign and magnitude of the partial derivatives indicate whether the choice of a new tuning variable value will reduce the cost function, thereby optimizing the linear regression algorithm. A new tuning variable value is selected depending on a set threshold. Depending on the machine learning module, a steep or gradual negative slope is selected. Both the cost function and gradient descent can be used with other algorithms and modules mentioned throughout. For the sake of brevity, both the cost function and gradient descent are well known in the art and are applicable to other machine learning algorithms and may not be mentioned with the same detail.

LiR models may have many levels of complexity comprising one or more independent variables. Furthermore, in an LiR function with more than one independent variable, each independent variable may have the same one or more tuning variables or each, separately, may have their own one or more tuning variables. The number of independent variables and tuning variables will be understood to one skilled in the art for the problem being solved. In example embodiments, user interaction histories are used as the independent variables to train a LiR machine learning module, which, after training, is used to estimate, for example, whether a user is likely to conduct a fraudulent interaction.

### Logistic Regression (LoR)

In one example embodiment, logistic regression machine learning is implemented. Logistic Regression, often considered a LiR type model, is typically used in machine learning to classify information, such as user interaction histories into categories such as whether a user is likely to conduct a fraudulent interaction. LoR takes advantage of probability to predict an outcome from input data. However, what makes LoR different from a LiR is that LoR uses a more complex logistic function, for example a sigmoid function. In addition, the cost function can be a sigmoid function limited to a result between 0 and 1. For example, the sigmoid function can be of the form (x)=1/(1+e^{-x}), where x represents some linear representation of input features and tuning variables. Similar to LiR, the tuning variable(s) of the cost function are optimized (typically by taking the log of some variation of the cost function) such that the result of the cost function, given variable representations of the input features, is a number between 0 and 1, preferably falling on either side of 0.5. As described in LiR, gradient descent may also be used in LoR cost function optimization and is an example of the process. In example embodiments, user interaction histories are used as the independent variables to train a LoR machine learning module, which, after training, is used to estimate, for example, whether a user is likely to conduct a fraudulent interaction.

### Bayesian Network

In one example embodiment, a Bayesian Network is implemented. BNs are used in machine learning to make predictions through Bayesian inference from probabilistic graphical models. In BNs, input features are mapped onto a directed acyclic graph forming the nodes of the graph. The edges connecting the nodes contain the conditional dependencies between nodes to form a predicative model. For each connected node the probability of the input features resulting in the connected node is learned and forms the predictive mechanism. The nodes may comprise the same, similar or different probability functions to determine movement from one node to another. The nodes of a Bayesian network are conditionally independent of its non-descendants given its parents thus satisfying a local Markov property. This property affords reduced computations in larger networks by simplifying the joint distribution.

There are multiple methods to evaluate the inference, or predictability, in a BN but only two are mentioned for demonstrative purposes. The first method involves computing the joint probability of a particular assignment of values for each variable. The joint probability can be considered the product of each conditional probability and, in some instances, comprises the logarithm of that product. The second method is Markov chain Monte Carlo (MCMC), which can be implemented when the sample size is large. MCMC is a well-known class of sample distribution algorithms and will not be discussed in detail herein.

The assumption of conditional independence of variables forms the basis for Naïve Bayes classifiers. This assumption implies there is no correlation between different input features. As a result, the number of computed probabilities is significantly reduced as well as the computation of the probability normalization. While independence between features is rarely true, this assumption exchanges reduced computations for less accurate predictions, however the predictions are reasonably accurate. In example embodiments, user interaction histories are mapped to the BN graph to train the BN machine learning module, which, after training, is used to estimate whether a user is likely to conduct a fraudulent interaction.

### Random Forest

In one example embodiment, random forest (“RF”) is implemented. RF consists of an ensemble of decision trees producing individual class predictions. The prevailing prediction from the ensemble of decision trees becomes the RF prediction. Decision trees are branching flowchart-like graphs comprising of the root, nodes, edges/branches, and leaves. The root is the first decision node from which feature information is assessed and from it extends the first set of edges/branches. The edges/branches contain the information of the outcome of a node and pass the information to the next node. The leaf nodes are the terminal nodes that output the prediction. Decision trees can be used for both classification as well as regression and is typically trained using supervised learning methods. Training of a decision tree is sensitive to the training data set. An individual decision tree may become over or under-fit to the training data and result in a poor predictive model. Random forest compensates by using multiple decision trees trained on different data sets. In example embodiments, user interaction histories are used to train the nodes of the decision trees of a RF machine learning module, which, after training, is used to estimate whether a user is likely to conduct a fraudulent interaction.

### Gradient Boosting

In an example embodiment, gradient boosting is implemented. Gradient boosting is a method of strengthening the evaluation capability of a decision tree node. In general, a tree is fit on a modified version of an original data set. For example, a decision tree is first trained with equal weights across its nodes. The decision tree is allowed to evaluate data to identify nodes that are less accurate. Another tree is added to the model and the weights of the corresponding underperforming nodes are then modified in the new tree to improve their accuracy. This process is performed iteratively until the accuracy of the model has reached a defined threshold or a defined limit of trees has been reached. Less accurate nodes are identified by the gradient of a loss function. Loss functions must be differentiable such as a linear or logarithmic functions. The modified node weights in the new tree are selected to minimize the gradient of the loss function. In an example embodiment, a decision tree is implemented to determine a user interaction histories and gradient boosting is applied to the tree to improve its ability to accurately determine whether a user is likely to conduct a fraudulent interaction.

### Neural Networks

In one example embodiment, Neural Networks are implemented. NNs are a family of statistical learning models influenced by biological neural networks of the brain. NNs can be trained on a relatively-large dataset (e.g., 50,000 or more) and used to estimate, approximate, or predict an output that depends on a large number of inputs/features. NNs can be envisioned as so-called “neuromorphic” systems of interconnected processor elements, or “neurons”, and exchange electronic signals, or “messages”. Similar to the so-called “plasticity” of synaptic neurotransmitter connections that carry messages between biological neurons, the connections in NNs that carry electronic “messages” between “neurons” are provided with numeric weights that correspond to the strength or weakness of a given connection. The weights can be tuned based on experience, making NNs adaptive to inputs and capable of learning. For example, an NN for user interaction histories is defined by a set of input neurons that can be given input data such as user transactions. The input neuron weighs and transforms the input data and passes the result to other neurons, often referred to as “hidden” neurons. This is repeated until an output neuron is activated. The activated output neuron produces a result. In example embodiments, user transaction histories and secondary user actions or data are used to train the neurons in a NN machine learning module, which, after training, is used to estimate whether a user is likely to conduct a fraudulent interaction.

### Convolutional Autoencoder

In example embodiments, convolutional autoencoder (CAE) is implemented. A CAE is a type of neural network and comprises, in general, two main components. First, the convolutional operator that filters an input signal to extract features of the signal. Second, an autoencoder that learns a set of signals from an input and reconstructs the signal into an output. By combining these two components, the CAE learns the optimal filters that minimize reconstruction error resulting an improved output. CAEs are trained to only learn filters capable of feature extraction that can be used to reconstruct the input. Generally, convolutional autoencoders implement unsupervised learning. In example embodiments, the convolutional autoencoder is a variational convolutional autoencoder. In example embodiments, features from user interaction histories are used as an input signal into a CAE which reconstructs that signal into an output such as a whether a user is likely to conduct a fraudulent interaction.

### Deep Learning

In example embodiments, deep learning is implemented. Deep learning expands the neural network by including more layers of neurons. A deep learning module is characterized as having three “macro” layers: (1) an input layer which takes in the input features, and fetches embeddings for the input, (2) one or more intermediate (or hidden) layers which introduces nonlinear neural net transformations to the inputs, and (3) a response layer which transforms the final results of the intermediate layers to the prediction. In example embodiments, user interaction histories are used to train the neurons of a deep learning module, which, after training, is used to estimate whether a user is likely to conduct a fraudulent interaction.

### Convolutional Neural Network (CNN)

In an example embodiment, a convolutional neural network is implemented. CNNs is a class of NNs further attempting to replicate the biological neural networks, but of the animal visual cortex. CNNs process data with a grid pattern to learn spatial hierarchies of features. Wherein NNs are highly connected, sometimes fully connected, CNNs are connected such that neurons corresponding to neighboring data (e.g., pixels) are connected. This significantly reduces the number of weights and calculations each neuron must perform.

In general, input data, such user interaction histories, comprises of a multidimensional vector. A CNN, typically, comprises of three layers: convolution, pooling, and fully connected. The convolution and pooling layers extract features and the fully connected layer combines the extracted features into an output, such as whether a user is likely to conduct a fraudulent interaction.

In particular, the convolutional layer comprises of multiple mathematical operations such as of linear operations, a specialized type being a convolution. The convolutional layer calculates the scalar product between the weights and the region connected to the input volume of the neurons. These computations are performed on kernels, which are reduced dimensions of the input vector. The kernels span the entirety of the input. The rectified linear unit (i.e., ReLu) applies an elementwise activation function (e.g., sigmoid function) on the kernels.

CNNs can optimized with hyperparameters. In general, there three hyperparameters are used: depth, stride, and zero-padding. Depth controls the number of neurons within a layer. Reducing the depth may increase the speed of the CNN but may also reduce the accuracy of the CNN. Stride determines the overlap of the neurons. Zero-padding controls the border padding in the input.

The pooling layer down-samples along the spatial dimensionality of the given input (i.e., convolutional layer output), reducing the number of parameters within that activation. As an example, kernels are reduced to dimensionalities of 2×2 with a stride of 2, which scales the activation map down to 25%. The fully connected layer uses inter-layer-connected neurons (i.e., neurons are only connected to neurons in other layers) to score the activations for classification and/or regression. Extracted features may become hierarchically more complex as one layer feeds its output into the next layer. See O'Shea, K.; Nash, R. An Introduction to Convolutional Neural Networks. arXiv 2015 and Yamashita, R., et al Convolutional neural networks: an overview and application in radiology. Insights Imaging 9, 611-629 (2018).

### Recurrent Neural Network (RNN)

In an example embodiment, a recurrent neural network is implemented. RNNs are class of NNs further attempting to replicate the biological neural networks of the brain. RNNs comprise of delay differential equations on sequential data or time series data to replicate the processes and interactions of the human brain. RNNs have “memory” wherein the RNN can take information from prior inputs to influence the current output. RNNs can process variable length sequences of inputs by using their “memory” or internal state information. Where NNs may assume inputs are independent from the outputs, the outputs of RNNs may be dependent on prior elements with the input sequence. For example, input such as user interaction histories is received by a RNN, which determines whether a user is likely to conduct a fraudulent interaction. See Sherstinsky, Alex. “Fundamentals of recurrent neural network (RNN) and long short-term memory (LSTM) network.” Physica D: Nonlinear Phenomena 404 (2020): 132306.

### Long Short-Term Memory (LSTM)

In an example embodiment, a Long Short-term Memory is implemented. LSTM are a class of RNNs designed to overcome vanishing and exploding gradients. In RNNs, long term dependencies become more difficult to capture because the parameters or weights either do not change with training or fluctuate rapidly. This occurs when the RNN gradient exponentially decreases to zero, resulting in no change to the weights or parameters, or exponentially increases to infinity, resulting in large changes in the weights or parameters. This exponential effect is dependent on the number of layers and multiplicative gradient. LSTM overcomes the vanishing/exploding gradients by implementing “cells” within the hidden layers of the NN. The “cells” comprise three gates: an input gate, an output gate, and a forget gate. The input gate reduces error by controlling relevant inputs to update the current cell state. The output gate reduces error by controlling relevant memory content in the present hidden state. The forget gate reduces error by controlling whether prior cell states are put in “memory” or forgotten. The gates use activation functions to determine whether the data can pass through the gates. While one skilled in the art would recognize the use of any relevant activation function, example activation functions are sigmoid, tanh, and RELU. See Zhu, Xiaodan, et al. “Long short-term memory over recursive structures.” International Conference on Machine Learning. PMLR, 2015.

### Matrix Factorization

In example embodiments, Matrix Factorization is implemented. Matrix factorization machine learning exploits inherent relationships between two entities drawn out when multiplied together. Generally, the input features are mapped to a matrix F which is multiplied with a matrix R containing the relationship between the features and a predicted outcome. The resulting dot product provides the prediction. The matrix R is constructed by assigning random values throughout the matrix. In this example, two training matrices are assembled. The first matrix X contains training input features and the second matrix Z contains the known output of the training input features. First the dot product of R and X are computed and the square mean error, as one example method, of the result is estimated. The values in R are modulated and the process is repeated in a gradient descent style approach until the error is appropriately minimized. The trained matrix R is then used in the machine learning model. In example embodiments, user interaction histories are used to train the relationship matrix R in a matrix factorization machine learning module. After training, the relationship matrix R and input matrix F, which comprises vector representations of user interaction histories, results in the prediction matrix P comprising whether a user is likely to conduct a fraudulent interaction.

### Hidden Markov Model

In example embodiments, a hidden Markov model is implemented. A HMM takes advantage of the statistical Markov model to predict an outcome. A Markov model assumes a Markov process, wherein the probability of an outcome is solely dependent on the previous event. In the case of HMM, it is assumed an unknown or “hidden” state is dependent on some observable event. A HMM comprises a network of connected nodes. Traversing the network is dependent on three model parameters: start probability; state transition probabilities; and observation probability. The start probability is a variable that governs, from the input node, the most plausible consecutive state. From there each node i has a state transition probability to node j. Typically the state transition probabilities are stored in a matrix Mᵢⱼ wherein the sum of the rows, representing the probability of state i transitioning to state j, equals 1. The observation probability is a variable containing the probability of output o occurring. These too are typically stored in a matrix Nₒⱼ wherein the probability of output o is dependent on state j. To build the model parameters and train the HMM, the state and output probabilities are computed. This can be accomplished with, for example, an inductive algorithm. Next, the state sequences are ranked on probability, which can be accomplished, for example, with the Viterbi algorithm. Finally, the model parameters are modulated to maximize the probability of a certain sequence of observations. This is typically accomplished with an iterative process wherein the neighborhood of states is explored, the probabilities of the state sequences are measured, and model parameters updated to increase the probabilities of the state sequences. In example embodiments, user interaction histories are used to train the nodes/states of the HMM machine learning module, which, after training, is used to estimate whether a user is likely to conduct a fraudulent interaction.

### Support Vector Machine

In example embodiments, support vector machines are implemented. SVMs separate data into classes defined by n-dimensional hyperplanes (n-hyperplane) and are used in both regression and classification problems. Hyperplanes are decision boundaries developed during the training process of a SVM. The dimensionality of a hyperplane depends on the number of input features. For example, a SVM with two input features will have a linear (1-dimensional) hyperplane while a SVM with three input features will have a planer (2-dimensional) hyperplane. A hyperplane is optimized to have the largest margin or spatial distance from the nearest data point for each data type. In the case of simple linear regression and classification a linear equation is used to develop the hyperplane. However, when the features are more complex a kernel is used to describe the hyperplane. A kernel is a function that transforms the input features into higher dimensional space. Kernel functions can be linear, polynomial, a radial distribution function (or gaussian radial distribution function), or sigmoidal. In example embodiments, user interaction histories are used to train the linear equation or kernel function of the SVM machine learning module, which, after training, is used to estimate whether a user is likely to conduct a fraudulent interaction.

### K-Means Clustering

In one example embodiment, K-means clustering is implemented. KMC assumes data points have implicit shared characteristics and “clusters” data within a centroid or “mean” of the clustered data points. During training, KMC adds a number of k centroids and optimizes its position around clusters. This process is iterative, where each centroid, initially positioned at random, is re-positioned towards the average point of a cluster. This process concludes when the centroids have reached an optimal position within a cluster. Training of a KMC module is typically unsupervised. In example embodiments, user interaction histories are used to train the centroids of a KMC machine learning module, which, after training, is used to estimate whether a user is likely to conduct a fraudulent interaction.

### K-Nearest Neighbor

In one example embodiment, K-nearest neighbor is implemented. On a general level, KNN shares similar characteristics to KMC. For example, KNN assumes data points near each other share similar characteristics and computes the distance between data points to identify those similar characteristics but instead of k centroids, KNN uses k number of neighbors. The k in KNN represents how many neighbors will assign a data point to a class, for classification, or object property value, for regression. Selection of an appropriate number of k is integral to the accuracy of KNN. For example, a large k may reduce random error associated with variance in the data but increase error by ignoring small but significant differences in the data. Therefore, a careful choice of k is selected to balance overfitting and underfitting. Concluding whether some data point belongs to some class or property value k, the distance between neighbors is computed. Common methods to compute this distance are Euclidean, Manhattan or Hamming to name a few. In some embodiments, neighbors are given weights depending on the neighbor distance to scale the similarity between neighbors to reduce the error of edge neighbors of one class “out-voting” near neighbors of another class. In one example embodiment, k is 1 and a Markov model approach is utilized. In example embodiments, user interaction histories are used to train a KNN machine learning module, which, after training, is used to estimate whether a user is likely to conduct a fraudulent interaction.

To perform one or more of its functionalities, the machine learning module may communicate with one or more other systems. For example, an integration system may integrate the machine learning module with one or more email servers, web servers, one or more databases, or other servers, systems, or repositories. In addition, one or more functionalities may require communication between a user and the machine learning module.

Any one or more of the module described herein may be implemented using hardware (e.g., one or more processors of a computer/machine) or a combination of hardware and software. For example, any module described herein may configure a hardware processor (e.g., among one or more hardware processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, to allow information to be passed between the applications so as to allow the applications to share and access common data.

### Multimodal Translation

In an example embodiment, the machine learning module comprises multimodal translation (MT), also known as multimodal machine translation or multimodal neural machine translation. MT comprises of a machine learning module capable of receiving multiple (e.g. two or more) modalities. Typically, the multiple modalities comprise of information connected to each other.

In example embodiments, the MT may comprise of a machine learning method further described herein. In an example embodiment, the MT comprises a neural network, deep neural network, convolutional neural network, convolutional autoencoder, recurrent neural network, or an LSTM. For example, one or more microscopy imaging data comprising multiple modalities from a subject is embedded as further described herein. The embedded data is then received by the machine learning module. The machine learning module processes the embedded data (e.g. encoding and decoding) through the multiple layers of architecture then determines the corresponding the modalities comprising the input. The machine learning methods further described herein may be engineered for MT wherein the inputs described herein comprise of multiple modalities. See e.g. Sulubacak, U., Caglayan, O., Grönroos, S A. et al. Multimodal machine translation through visuals and speech. Machine Translation 34, 97-147 (2020) and Huang, Xun, et al. “Multimodal unsupervised image-to-image translation.” Proceedings of the European conference on computer vision (ECCV). 2018.

The ladder diagrams, scenarios, flowcharts and block diagrams in the figures and discussed herein illustrate architecture, functionality, and operation of example embodiments and various aspects of systems, methods, and computer program products of the present invention. Each block in the flowchart or block diagrams can represent the processing of information and/or transmission of information corresponding to circuitry that can be configured to execute the logical functions of the present techniques. Each block in the flowchart or block diagrams can represent a module, segment, or portion of one or more executable instructions for implementing the specified operation or step. In example embodiments, the functions/acts in a block can occur out of the order shown in the figures and nothing requires that the operations be performed in the order illustrated. For example, two blocks shown in succession can executed concurrently or essentially concurrently. In another example, blocks can be executed in the reverse order. Furthermore, variations, modifications, substitutions, additions, or reduction in blocks and/or functions may be used with any of the ladder diagrams, scenarios, flow charts and block diagrams discussed herein, all of which are explicitly contemplated herein.

The ladder diagrams, scenarios, flow charts and block diagrams may be combined with one another, in part or in whole. Coordination will depend upon the required functionality. Each block of the block diagrams and/or flowchart illustration as well as combinations of blocks in the block diagrams and/or flowchart illustrations can be implemented by special purpose hardware-based systems that perform the aforementioned functions/acts or carry out combinations of special purpose hardware and computer instructions. Moreover, a block may represent one or more information transmissions and may correspond to information transmissions among software and/or hardware modules in the same physical device and/or hardware modules in different physical devices.

The present techniques can be implemented as a system, a method, a computer program product, digital electronic circuitry, and/or in computer hardware, firmware, software, or in combinations of them. The system may comprise distinct software modules embodied on a computer readable storage medium; the modules can include, for example, any or all of the appropriate elements depicted in the block diagrams and/or described herein; by way of example and not limitation, any one, some, or all of the modules/blocks and or sub-modules/sub-blocks described. The method steps can then be carried out using the distinct software modules and/or sub-modules of the system, as described above, executing on one or more hardware processors.

It is to be further understood that embodiments of the invention may be implemented as processes of a computer program product, each process of which is operable on one or more processors either alone on a single physical platform, such as a personal computer, a laptop computer, a smart phone, or across a plurality of platforms, such as a system or network, including networks such as the Internet, an intranet, a Wide Area Network (WAN), a Local Area Network (LAN), a cellular network, or any other suitable network. Embodiments of the invention may employ client devices that may each comprise a computer-readable medium, including but not limited to, Random Access Memory (RAM) coupled to a processor. The processor may execute computer-executable program instructions stored in memory. Such processors may include, but are not limited to, a microprocessor, an Application Specific Integrated Circuit (ASIC), and/or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

In addition, it is to be understood that client devices that may be employed by embodiments of the invention may also comprise a number of external or internal devices, such as a CD-ROM, DVD, touchscreen display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a RAM. Such server devices, which may be a single computer system, may also be implemented as a network of computer processors. Examples of such server devices are servers, mainframe computers, networked computers, a processor-based device, and similar types of systems and devices.

What is claimed is:

1. A system to use machine learning algorithms to create user interaction tiers to identify fraudulent activities, comprising:
a storage device; and
a processor communicatively coupled to the storage device, wherein the processor executes application code instructions that are stored in the storage device to cause a machine learning algorithm to:
define a first tier of user accounts of an entity, the user accounts being counterparties to interactions with other user accounts based on an analysis of at least 180 days of interaction history of the user accounts;
define a second tier of user accounts comprising each of a plurality of user accounts that is an interaction counterparty user account of at least one of the first tier user accounts based on an analysis of at least 180 days of interaction history of each user account;
define a third tier of user accounts comprising each of a plurality of user accounts that is an interaction counterparty user account of at least one of the second tier user accounts based on an analysis of at least 180 days of interaction history of each user account;
create user models for each of the first tier user accounts based on interactions of each user account and the user accounts of the second tier user accounts and the third tier user accounts associated with each the first tier user account; and
compare the user models for each of the first tier user accounts to identify patterns or correlations indicative of a fraudulent interaction in the interaction history of the user account.

2. The system of claim 1, wherein the fraudulent interaction is identified by the machine learning algorithm based on patterns, trends, correlations, or connections between user accounts and interactions.

3. The system of claim 1, further comprising application code instructions to label as fraudulent previously unlabeled interactions if the comparison identifies the interaction as fraudulent.

4. The system of claim 1, further comprising application code instructions to cluster first tier user accounts in which users associated with the user accounts have similar characteristics.

5. The system of claim 4, further comprising application code instructions to identify a user account in which interactions in the interaction history of the user account differs from expected interactions based on the characteristics of a cluster of first tier accounts in which the user account is clustered.

6. The system of claim 4, wherein the cluster is based on characteristics comprising one or more of user locations, user ages, user account types, and user occupations.

7. The system of claim 4, further comprising application code instructions to identify a cluster in which interactions in the interaction history of the user accounts in the cluster differ from expected interactions based on the previous interactions of the cluster.

8. The system of claim 1, further comprising application code instructions to analyze real time interactions as data is received from a pending interaction.

9. The system of claim 8, further comprising application code instructions to decline an interaction in real time when the analysis identifies the interaction as fraudulent.

10. The system of claim 8, wherein the analysis of real time interactions is based on comparison of received data to each of the interactions of each of the first tier user accounts.

11. The system of claim 1, wherein the indications of fraudulent activity are based on one or more of a geographic location of user accounts, a time of day of an interaction, a type of interaction, and a history of fraudulent activities of a counterparty of the interaction.

12. The system of claim 1, wherein the machine learning algorithm used is a deep neural network.

13. The system of claim 1, further comprising application code instructions to:
define a fourth tier of user accounts comprising each of a plurality of user accounts that is an interaction counterparty user account of at least one of the third tier user accounts based on an analysis of at least 180 days of interaction history of each user account; and
modify the user models for each of the first tier user accounts based on interactions of each user account and the user accounts of the second tier user accounts and the third tier user accounts associated with each the first tier user account and the fourth tier user accounts associated with each the first tier user account.

14. The system of claim 1, further comprising application code instructions to generate an alert when an interaction or a user account is identified as fraudulent.

15. The system of claim 1, further comprising application code instructions to label as a high risk user a first tier user that has a number of fraudulent interaction in the interaction history of the user account that is greater than a configured threshold.

16. A method, comprising:
defining, by a machine learning algorithm, a first tier of user accounts of an entity, the user accounts being counterparties to interactions with other user accounts based on an analysis of at least 180 days of interaction history of the user accounts;
defining, by the machine learning algorithm, a second tier of user accounts comprising each of a plurality of user accounts that is an interaction counterparty user account of at least one of the first tier user accounts based on an analysis of at least 180 days of interaction history of each user account;
defining, by the machine learning algorithm, a third tier of user accounts comprising each of a plurality of user accounts that is an interaction counterparty user account of at least one of the second tier user accounts based on an analysis of at least 180 days of interaction history of each user account;
creating, by the machine learning algorithm, user models for each of the first tier user accounts based on interactions of each user account and the user accounts of the second tier user accounts and the third tier user accounts associated with each the first tier user account; and
comparing, by the machine learning algorithm, the user models for each of the first tier user accounts to identify patterns or correlations indicative of a fraudulent interaction in the interaction history of the user account.

17. The method of claim 16, wherein the fraudulent interaction are identified by the machine learning algorithm based on patterns, trends, correlations, or connections between user accounts and interactions.

18. The method of claim 16, further comprising clustering first tier user accounts in which users associated with the user accounts have similar characteristics.

19. The method of claim 16, further comprising analyzing real time interactions as data is received from a pending interaction.

20. The method of claim 16, wherein the indications of fraudulent activity are based on one or more of a geographic location of user accounts, a time of day of an interaction, a type of interaction, and a history of fraudulent activities of a counterparty of the interaction.
